(19) United States
(12) Patent Application Publication
(10) Pub. No.: US 2011/0023134 A1
(43) Pub. Date: Jan. 27, 2011

(54) NETWORK BASED CASUALTY LOSS PREVENTION SYSTEM

(76) Inventor: PHILLIP A. REMAKER, San Jose, CA (US)

Correspondence Address: PATTERSON & SHERIDAN, LLP/CISC, 3040 POST OAK BLVD., SUITE 1500, HOUSTON, TX, 77056-6582, US

(21) Appl. No.: 12/507,672

(22) Filed: Jul. 22, 2009

(51) Int. Cl. G06F 21/04; G06F 15/16

(52) U.S. Cl. 726/35; 709/206

(57) ABSTRACT

A method and apparatus for retrieving lost or stolen network devices. The network devices may be configured with loss prevention logic that may be enabled during initial setup of the network device. The loss prevention logic may detect predefined events that occur at the network device and generate messages to a server upon detecting the predefined events. The messages may include a location, for example, an IP address of the network device, which may enable authorities to locate and retrieve lost or stolen network devices. Once enabled, the loss prevention may be disabled by a predefined message received from the server.

### TECHNICAL FIELD

The present disclosure relates generally to equipment that is capable of accessing a network, and more specifically to the security of such equipment.

### BACKGROUND

Remotely placed network devices such as access points, routers, and other computing devices can be at risk of being stolen, vandalized, or otherwise tampered with, when placed in areas that have limited physical security or monitoring. Network devices can be stolen from both public and private locations such as homes, schools, libraries, businesses, where access to a network is desired but adequate physical security and monitoring of the devices may not be present. Such stolen devices are generally sold in a secondary market by unauthorized sellers, and may be used to access a public network without incurring any charge.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 illustrates an example system according to an embodiment.

FIG. 2 is a flow diagram of example operations performed by loss prevention logic according to an embodiment.

FIG. 3 illustrates an example message sent from a network device to a server, according to an embodiment.

FIG. 4 is a flow diagram of example operations performed by a network manager, according to an embodiment.

FIGS. 5A and 5B illustrate an example device list, according to an embodiment.

FIG. 6 illustrates an example message sent from a server to a network device, according to an embodiment.

FIG. 7 illustrates another example system, according to an embodiment.

### DESCRIPTION

### Overview

Certain embodiments of the present disclosure provide techniques and corresponding apparatus for operating a network device. The techniques generally comprise detecting occurrence of a predefined event at the network device, and in response to detecting the occurrence of the predefined event, determining whether loss prevention logic has been enabled. The method further comprises accessing a protected area of memory to retrieve an address of a server upon determining that loss prevention has been enabled, and generating a message to the server, the message indicating a location of the network device.

### Description

Embodiments of this disclosure are generally related to a method and apparatus for locating lost or stolen network devices. A network device may be configured with loss prevention logic that may be enabled during initial setup of the network device. The loss prevention logic may generate messages to a server upon detecting predefined events. The messages may include, for example, an IP address of the network device, which may enable authorities to locate and retrieve lost or stolen network devices.

In the following, reference is made to various embodiments. However, it should be understood that the claims are not limited to specific described embodiments. Instead, any combination of the following features and elements, whether related to different embodiments or not, is contemplated. Furthermore, in the various embodiments described provide numerous advantages over the prior art. However, although the embodiments may achieve advantages over other possible solutions and/or over the prior art, whether or not a particular advantage is achieved by a given embodiment is not limiting on the claims. Thus, the following aspects, features, embodiments and advantages are merely illustrative and are not considered elements or limitations of the appended claims except where explicitly recited in a claim(s). Likewise, reference to “the embodiments” shall not be construed as a generalization of any inventive subject matter disclosed herein and shall not be considered to be an element or limitation of the appended claims except where explicitly recited in a claim(s).

In general, the routines executed to implement the embodiments, may be part of an operating system or a specific application, component, program, module, object, or sequence of instructions. The computer program of the present disclosure typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the disclosure. However, it should be appreciated that any particular program nomenclature that follows is used merely for convenience, and thus this disclosure should not be limited to use solely in any specific application identified and/or implied by such nomenclature.

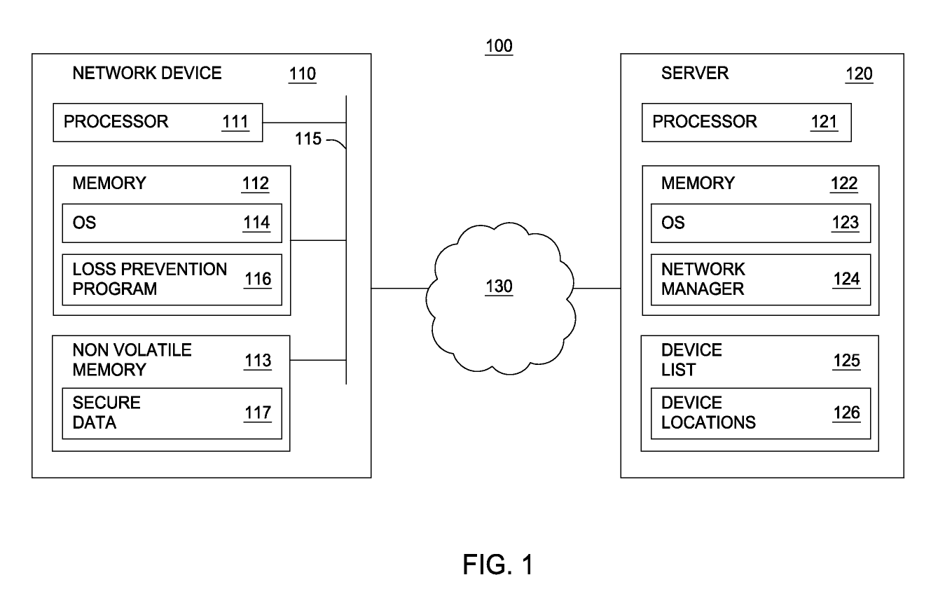

FIG. 1 illustrates an example networked system 100, according to an embodiment of this disclosure. As illustrated in FIG. 1, the networked system 100 may include a network device 110 coupled with a server 120 via a network 130. While a single network device 110 and a single server 120 are illustrated in FIG. 1, in alternative embodiments, a plurality of network devices 110 and servers 120 may be included in the network 130. In general, the network 130 may be any one of a local area network (LAN), a wide area network (WAN), Metropolitan Area Network (MAN), or the like. In a particular embodiment, the network 130 is the Internet. In one embodiment, the network 130 may include any combination of wired and/or wireless sub-networks.

The network device 110 may be any device that is configured to receive data from and/or transfer data to another device coupled to the network 130. Example network devices 110 may include, for example, gateways, routers, bridges, switches, hubs, and repeaters. As illustrated in FIG. 1, the network device 110 may include a processor 111 coupled to a memory 112 and a non-volatile memory 113 via a bus 115.

The processor 111 may be configured to execute instructions that are included in one or more programs stored in memory 112. The memory 112 is preferably a random access memory sufficiently large to hold necessary programming to perform one or more operations described herein. While memory 112 is shown as a single entity, it should be understood that memory 112 may in fact comprise a plurality of modules, and that memory 112 may exist at multiple levels, from high speed registers and caches to lower speed but larger DRAM chips.

The memory 112 may include an operating system 114 and loss prevention program 116, as illustrated in FIG. 1. The operating system 114 may be a network oriented operating system such as, for example, the Internetworking Operating System (IOS) commercially available from Cisco Systems, Inc. The processor 111 may execute one or more applications such as the loss prevention program 116 under control of the operating system 114. The loss prevention program 116 may be configured to perform operations that facilitate discovery and/or reporting of unauthorized uses of the networking device 110, as is discussed in greater detail below.

The non-volatile memory 113 may be any type of memory that is capable of storing information even when the networking device 110 is not powered. Examples of non-volatile memory include read only memories, flash memories and magnetic disks. In a particular embodiment, the non-volatile memory is an Electrically Erasable Programmable Read Only Memory (EEPROM).

As illustrated in FIG. 1, non-volatile memory 113 may include secure data 117. The secure data 117 may be accessed by the loss prevention program 116 while performing operations that facilitate discovery and/or reporting of unauthorized uses of the networking device 110, as is discussed below. In one embodiment, the secure data 117 may be stored in a predefined area of the non-volatile memory 113. In a particular embodiment, the contents of the predefined area of non-volatile memory may be a protected area that cannot be modified or easily accessed.

For example, in one embodiment, the predefined area of the non-volatile memory 113 may be protected using any combination of techniques such as, for example, sealed storage, memory curtaining, or the like. The sealed storage technique involves generating cryptographic keys for accessing data (such as the secure data 117) based on the identity of software requesting the data and the identity of the computer on which the software is running. The sealed storage technique may help ensure that only authorized software can access the data on an authorized machine. For example, sealed storage may ensure that only the loss prevention program 116 stored in a predefined network device 110 has access to the secure data 117.

Memory curtaining prevents a program from reading or writing data (such as the secure data 117) to and from memory locations associated with another program. In one embodiment even the operating system 114 may not have access to curtained memory. Therefore, memory curtaining may prevent an unauthorized user from taking over the operating system or other code and attempting to access the secure data 117.

The server 120 may be a general purpose computer system including at least one processor 121 and a memory 122, as illustrated in FIG. 1. In general, the server 120 may be configured to perform network management operations, as described herein. The processor 121 may be configured to execute instructions stored in memory 122. The memory 122 is preferably a random access memory sufficiently large to hold necessary programming to perform one or more operations described herein. While memory 122 is shown as a single entity, it should be understood that memory 122 may in fact comprise a plurality of modules, and that memory 122 may exist at multiple levels, from high speed registers and caches to lower speed but larger DRAM chips.

The memory 122 is shown comprising an operating system 123, a network manager 124 and a device list 125. Illustrative operating systems, which may be used to advantage, include Linux (Linux is a trademark of Linus Torvalds in the US, other countries, or both) and Microsoft's Windows NT®. More generally, any operating system supporting the functions disclosed herein may be used.

The network manager 124 may be an application configured to communicate with one or more network devices 110 coupled with the network 130 and determine whether an unauthorized use of the network device has occurred. The operations of the network manager are described in greater detail below.

The device list 125 may include a list of network devices 110 known to be accessible via the network 130. In one embodiment of the disclosure, the device list may include a unique identification value for the network devices 110. For example, in one embodiment, the device list 125 may include any combination of a device serial number, manufacturer number, media access control (MAC) address, hardware identification number, or any other unique identification value associated with each of the network devices 110.

The device list 125 may also include device locations 126, as illustrated in FIG. 1. The device locations 126 may indicate a last known physical location of the network devices 110 in the device list 125. For example, in one embodiment, the device locations 126 may include an Internet Protocol (IP) address indicating a location of each of the network devices 110 in the device list 125.

The loss prevention program 116 of the network device 110 and the network manager 124 of the server 120 may be configured to communicate with each other via the network 130 using a predefined network communication protocol. Example communication protocols may include, for example, the Transmission Control Protocol (TCP), Internet Protocol (IP), Dynamic Host Configuration Protocol (DHCP), Simple Network Management Protocol (SNMP), or the like.

In one embodiment, the loss prevention program 116 may be configured to detect one or more predefined events that occur at the network device 110 to determine whether communication with the server 120 is necessary. In some embodiments, the predefined events may indicate unauthorized use or attempts to tamper with the network device 110. Example predefined events may include booting up of the network device 110 and restarting the network device 110. For example, the loss prevention logic 116 may be configured to detect unauthorized attempts to access protected areas of memory 112 and/or non-volatile memory 113.

Upon detecting such a predefined event, the loss prevention program 116 may access the secure data 117. In one embodiment, the secure data 117 may include an address of the server 120, allowing the network device 110 to “call home” to alert the server 120 regarding the detected event. In alternative embodiments, the secure data may include a plurality of addresses for a respective plurality of different servers 120. The secure data 117 may also include a unique identification value associated with the network device 110, for example, a device serial number, manufacturer number, media access control (MAC) address, hardware identification number, or the like that allows the server 120 to identify the network device 110 that is calling home.

In one embodiment, the loss prevention program may be configured to generate and send a message to the address of the server 120 provided in the secure data 117 when a predefined event occurs. The message may be transferred based on an established network communication protocol. In a particular embodiment, the transfer of messages between the network device 110 and the server 120 may be performed on an encrypted channel.

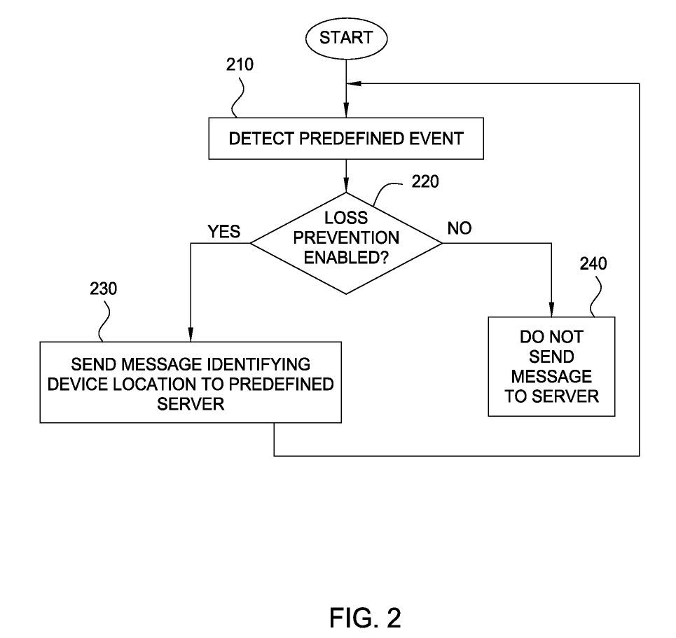

FIG. 2 is a flow diagram of example operations performed by the loss prevention program 116, according to an embodiment of this disclosure. The operations may begin in step 210 by detecting a predefined event such as, for example, boot up or restart of the network device 110. In step 220, the loss prevention program may determine whether loss prevention has been enabled. For example, the loss prevention program may access the secure data 117 to determine whether loss prevention is enabled. If loss prevention is enabled, then in step 230, the loss prevention program 116 may send a message identifying a location of the network device to a predefined server. The address of the server may be retrieved from the secure data 117, as described above. On the other hand, if the loss prevention logic is not enabled, the loss prevention program 116 may not send any message to the server, as indicated in step 240.

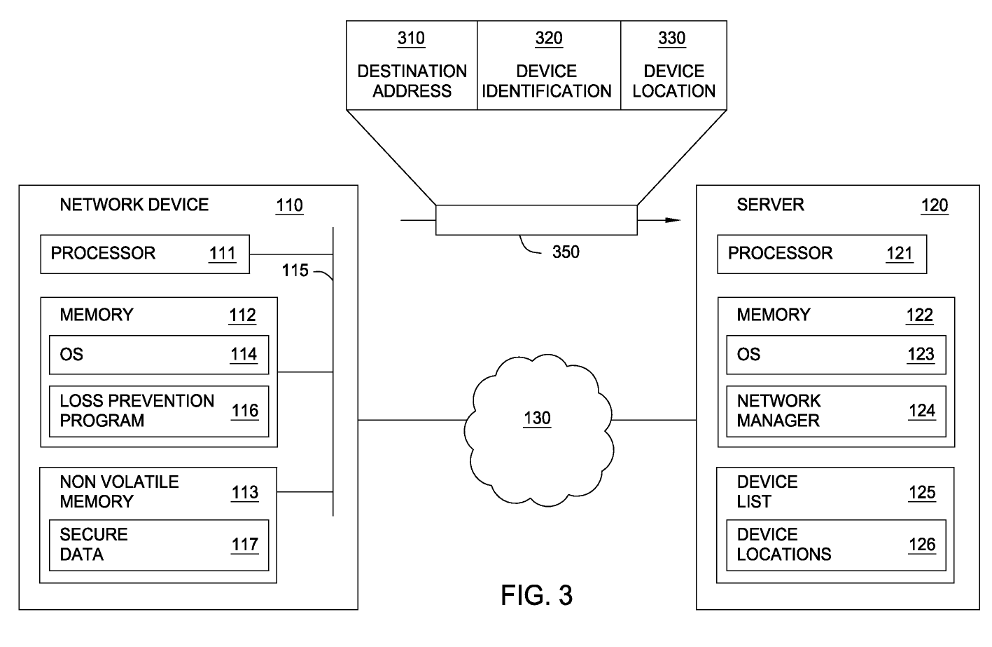

FIG. 3 illustrates a more detailed view of a message 350 that is transferred from the network device 110 to the server 120, according to an embodiment. As illustrated in FIG. 3, the message 150 may include a plurality of fields including a destination address field 310, a device identification field 320 and a device location field 330. In one embodiment, each field of the message 350 may include a predefined number of bits. The destination address field may include the address of the server 120 that is retrieved from the secure data 117. The destination address field 310 may be provided so that the message 350 can be properly routed to the server 120 via the network 130.

The device identification field 320 may include a unique identification of the network device 110 sending the message 350, for example, a serial number of the network device 110. The device location field 330 may include an address, for example, the IP address of the network device 110. While three fields are illustrated in FIG. 3, the message 350 may include any number of additional fields, such as an error correction field comprising error correction bits, etc.

Upon receiving the message 350, the network manager 124 at the server 120 may update the location of the network device 110 in the device locations 126 of the device list 125. In one embodiment of this disclosure, the device list 125 may include an indication of whether one or more of the network devices included therein have been reported as stolen, lost, or otherwise tampered with. Therefore, in one embodiment, if a message 350 is received from a network device 110 that has been flagged as stolen, lost, or otherwise tampered with, the network manager 124 may perform a predefined action for alerting a proper authority. For example, in one embodiment, the network manager 124 may generate a report to an administrator, a network security organization, law enforcement authority, or the like. The report may include a description and identification of the network device 110 and a location of the device indicated in the message 350. Therefore, the network manager 124 may facilitate recapture and return of lost or stolen network devices.

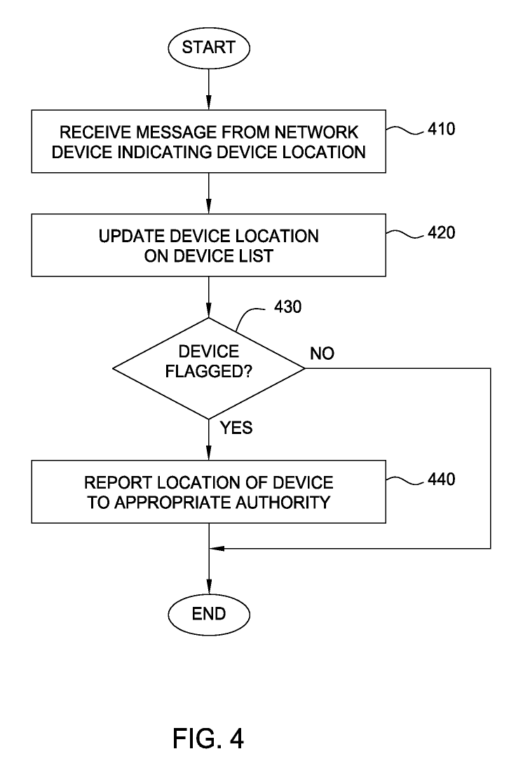

FIG. 4 is a flow diagram of example operations performed by the network manager 124, according to an embodiment of this disclosure. The operations may begin in step 410 by receiving a message from a network device 110 indicating a location of the network device. In step 420, the network manager may update a device list at the server 120. The device list may be configured to store the last known location of the network device 110. In step 430, the network manager 124 may determine whether the network device has been flagged. The network device may be flagged if it is known that the network device is lost, stolen or has otherwise been tampered with.

If the network device has not been flagged, the operations may end, as illustrated in FIG. 4. However, if the network device has been flagged, the network manager 124 may report the location of the network device to an appropriate authority, for example, a network administrator, law enforcement, or the like.

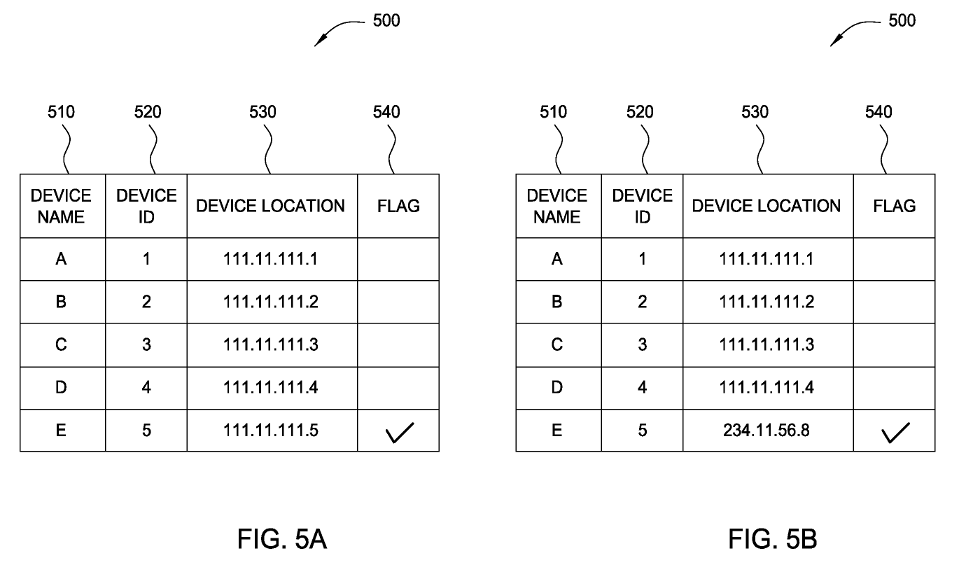

FIGS. 5A and 5B illustrate an example device list 500, according to an embodiment of this disclosure. The devices listed in the device list 500 may be examples of the network device 110 illustrated in FIG. 1. As illustrated in FIG. 5A, the device list 500 may include a plurality fields including, for example, a device name field 510, a device identification fields 520, device location field 530, and flag field 540. The device name and device identification fields 510 and 520 may identify one or more network devices that are associated with a server 120 including the device list 500. The device locations field 530 may store a last known address, for example, an IP address of each of the devices in the device list 500. The flag field 540 may indicate whether a network device has been identified as stolen, lost, or otherwise tampered with. For example, the check in field 540 for device E may indicate that the device has been flagged as stolen or lost.

If the lost or stolen device E sends a message 350 to the server 120, the network manager 124 may update the device location in the field 530 using an IP address provided in the message 350. For example, FIG. 5B illustrates the device list 500 after receiving a message 350 from the lost or stolen device E. As illustrated in the field 530 of FIG. 5B, the network manager has updated the device location for the network device E from 111.11.111.5 to 234.11.56.8. Furthermore, as discussed above, the network manager 124 may report the new location of the lost or stolen device E to the appropriate authorities so that the device E can be retrieved.

In one embodiment, a network device 110 may be configured to send the message 350 to a server during initial set-up of the network device 110. For example, during initial configuration, the loss prevention program 116 may generate a graphical user interface (GUI) screen which may allow a user to either enable or disable the loss prevention program 116. For example, the loss prevention program 116 may generate a prompt comprising a checkbox, dropdown menu, radio buttons, or the like, which facilitate a user selection to enable or disable the loss prevention program 116.

If enabled, the loss prevention program 116 may be configured to send the message 350 to the server 120 each time a predefined event occurs. For example, the loss prevention program 116 may send the message 350 to the server 120 when the network device 110 boots up. In one embodiment, while the loss prevention program 116 may be enabled via user input to the network device 110, once enabled, user input may not be able to disable the loss prevention logic 116. For example, in one embodiment, the enablement status of the loss prevention program 116 may be stored in the secure data 117, which may not be easily accessed or modified. In one embodiment, upon detecting a predefined event, the loss prevention logic 116 may access the secure data 117 to determine whether loss prevention is enabled. The message 350 may be sent only if the secure data 117 indicates that loss prevention is enabled.

In one embodiment of this disclosure, the loss prevention program 116 may be disabled only by a message received from the server 120. For example, a user that wants to disable loss prevention operations on a network device on which the loss prevention program 116 has been enabled may call a service provider that operates the server 120 requesting the disabling of loss prevention. Upon verification of the user's identity, an administrator or other authorized person may generate a predefined message to the user's network device 110. Upon receiving the predefined message from the server 120, the loss prevention program 116 of the network device 110 may stop generating the messages 350 when the predefined events occur.

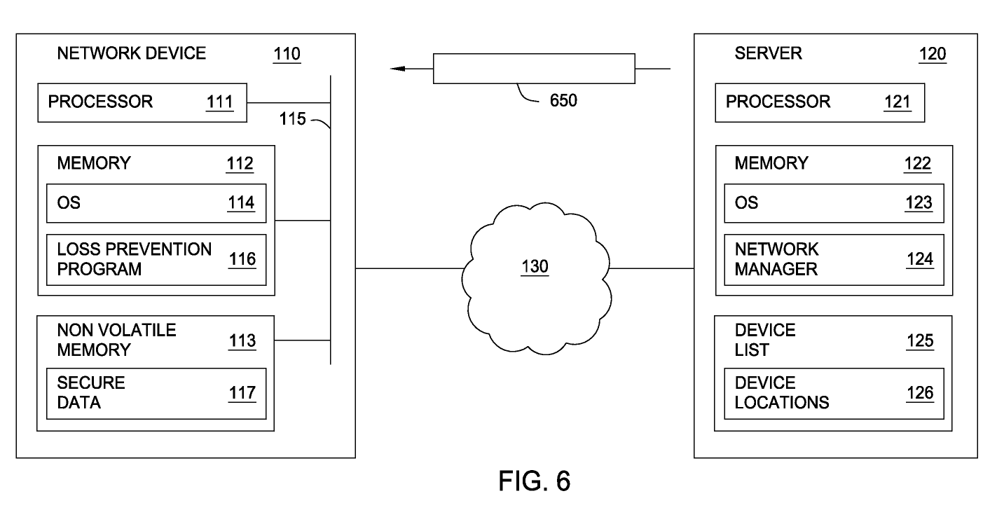

FIG. 6 illustrates an example message 650 that is sent from the server 120 to a network device 110 to disable loss prevention. The message 650 may include a unique operation code which indicates that loss prevention should be disabled. Upon receiving the message 650, the loss prevention program 116 of the network device 110 may disable the loss prevention operations described hereinabove.

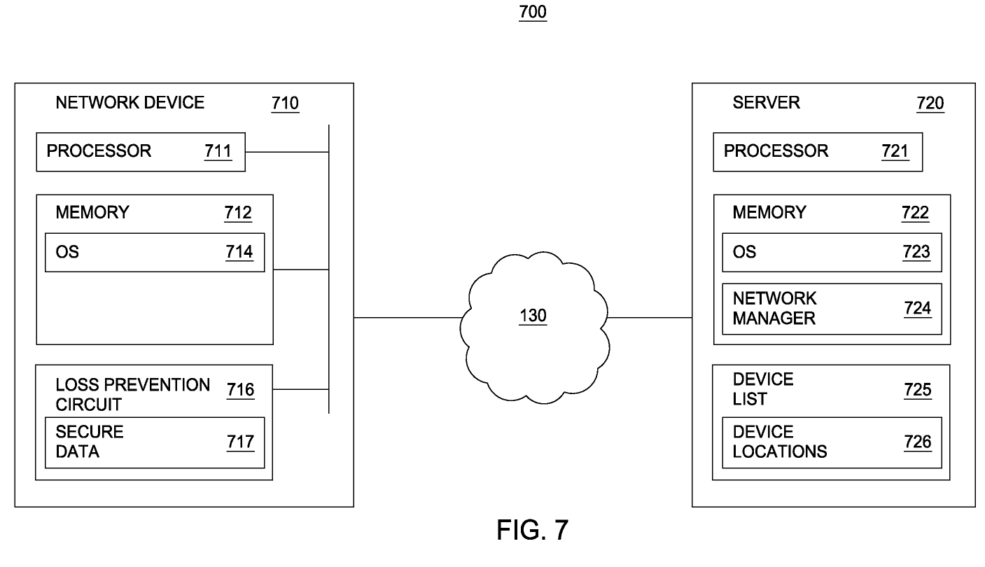

FIG. 7 illustrates an alternative system 700, according to an embodiment of this disclosure. As with system 100 of FIG. 1, the system 700 may also include a network device 710 and a server 720 coupled via a network 130. The server 720 may be arranged similar to the server 120 illustrated in FIG. 1. Accordingly, the server 720 is shown comprising a processor 721 and a memory 722 comprising operating system 723, network manager 724, and device list 725, which correspond to the processor 121 and memory 122 comprising operating system 123, network manager 124, and device list 125 respectively in FIG. 1.

The network device 710 may include a processor 711 and memory 712 that may correspond to the processor 111 and memory 112 respectively of the network device 110 of FIG. 1. However, the network device 710 does not include a loss prevention program, as is the case with the network device 110. Instead, the network device 710 includes a loss prevention circuit 716, as illustrated in FIG. 7. The loss prevention circuit 716 may be an application specific integrated circuit (ASIC) configured to perform the same operations as the loss prevention program 116. For example, the loss prevention circuit 716 may generate GUI's for enabling loss prevention during configuration of the network device 710, detect predefined events that occur at the network device 710, and send messages identifying a location of the network device 710 to the server 720 when a predefined event is detected.

In one embodiment of this disclosure, the loss prevention circuit may include the secure data 717, which corresponds to the secure data 117 described hereinabove. Alternatively, the secure data 717 may be stored in non-volatile memory that may be accessible to the loss prevention circuit 716. In one embodiment, the secure data may be protected such that only the loss prevention circuit 716 has access thereto.

By generating messages indicating the location of a network device to a server when certain predefined events occur at the network device, embodiments of this disclosure facilitate the retrieval of network devices that may be lost, stolen, or otherwise tampered with. The message generating features and message data may be stored in protected locations of memory such that the features cannot be disabled by an unauthorized person.

While the foregoing is directed to embodiments of the present disclosure, other and further embodiments of the disclosure may be devised without departing from the basic scope thereof, and the scope thereof is determined by the claims that follow.

1. A method for operating a network device, comprising:
detecting occurrence of a predefined event at the network device;
in response to detecting the occurrence of the predefined event, determining whether loss prevention logic has been enabled;
upon determining that loss prevention logic has been enabled, accessing a protected area of memory to retrieve an address of a server; and
generating a message to the server, the message indicating a location of the network device.

2. The method of claim 1, wherein determining whether loss prevention logic has been enabled comprises accessing the protected area of memory.

3. The method of claim 1, wherein the loss prevention logic is enabled during initial configuration of the network device.

4. The memory circuit of claim 3, wherein once enabled, the loss prevention can be disabled only by a predefined message received from the server.

5. The method of claim 1, wherein the loss prevention logic is included in any one of:
an application stored in the memory; and
a loss prevention circuit.

6. The method of claim 1, wherein the memory is a non-volatile memory.

7. The method of claim 1, wherein the message comprises:
a unique identification value associated with the network device; and
an Internet Protocol (IP) address of the network device.

8. A computer readable storage medium comprising a program product which, when executed, is configured to perform an operation for operating a network device, the operation comprising:
detecting occurrence of a predefined event at the network device;
in response to detecting the occurrence of the predefined event, determining whether loss prevention logic has been enabled;
upon determining that loss prevention has been enabled, accessing a protected area of memory to retrieve an address of a server; and
generating a message to the server, the message indicating a location of the network device.

9. The computer readable storage medium of claim 8, wherein determining whether loss prevention logic has been enabled comprises accessing the protected area of memory.

10. The computer readable storage medium of claim 8, wherein the loss prevention logic is enabled during initial configuration of the network device.

11. The computer readable storage medium of claim 10, wherein once enabled, the loss prevention can be disabled only by a predefined message received from the server.

12. The computer readable storage medium of claim 8, wherein the loss prevention logic is included in any one of:
an application stored in the memory; and
a loss prevention circuit.

13. The computer readable storage medium of claim 8, wherein the memory is a non-volatile memory.

14. The computer readable storage medium of claim 8, wherein the message comprises:
a unique identification value associated with the network device; and
an Internet Protocol (IP) address of the network device.

15. An apparatus, comprising:
a first memory device having a protected area for storing an address of a server; and
loss prevention logic configured to, if enabled, detect occurrence of a predefined event and, in response, access the protected area of the memory to retrieve the address of the server, and generate a message to the server indicating a location of the network device.

16. The apparatus of claim 15, further comprising:
a second memory device for storing an indication of whether or not the loss prevention logic is enabled.

17. The apparatus of claim 16, wherein the second memory comprises a non-volatile memory and is accessible by the server.

18. The apparatus of claim 15, wherein the loss prevention logic is enabled during initial configuration of the network device.

19. The apparatus of claim 15, wherein once enabled, the loss prevention logic can be disabled only by a predefined message received from the server.

20. The apparatus of claim 15, wherein the message comprises:
a unique identification value associated with the apparatus; and
an Internet Protocol (IP) address of the network device.
